(19) United States
(12) Patent Application Publication
(10) Pub. No.: US 2008/0103974 A1
(43) Pub. Date: May 1, 2008

(54) MOVIE KEY

(76) Inventors: Michael Fridhendler, Naharia (IL); Avi Erez, Haifa (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/554,145

(22) Filed: Oct. 30, 2006

(51) Int. Cl. H04L 9/00

(52) U.S. Cl. 705/52

(57) ABSTRACT

Disclosed are a system and a method which enable utilizing rewritable portable memory devices, such as flash memory keys, for digital media content rentals, such as movies and audio files, while ensuring the security of the media content stored on the device. Users rent media content from dedicated digital media kiosks by loading it onto pre-purchased memory devices. The media content may be played using any standard desktop or laptop computer or using a dedicated player box. The rental terms defines the number of times the users may play the content or the amount of time the content would be in their disposal. In order to protect the rented content the memory device limits the accessibility of the content to the users, the users cannot download the entire media content to their computer, and only have access to sections of the media content at a time while playing it.

### FIELD OF INVENTION

The present invention relates to the field of digital media rental, more particularly it relates to a system and a method for secure rental of media content using a rewritable portable device.

### BACKGROUND OF PRIOR ART

As the use of portable rewritable memory devices, such as flash memory keys, becomes more commonplace, and as their ability to store larger memory units, the possibility of using them instead of disposable memory units, such as compact discs (CDs) or digital versatile discs (DVDs) is becoming more feasible. Known in the art are several solutions for making use of such memory devices for the purpose of renting-out digital media content.

International Patent Application No. 2005074432 discloses a digital media distribution system with a media distribution infrastructure that interfaces with a portable digital media card. US Patent Application No. 20020095680 discloses a personal movie storage module including a storage device having an atomic resolution storage device memory component capable of storing at least one movie and a communication interface which communicates to and from the memory component of the storage module. US Patent Application No. 20050049931 discloses a digital content kiosk system operable for delivering selected digital content to a user. The digital content kiosk system includes a limited-play recordable data storage medium configured to receive selected digital content and a data storage media recording device operable for recording the selected digital content on the limited-play recordable data storage medium at the request of a user.

However, none of the above mentioned patents and patent applications provides a system and a method which ensure that the users of such means do not have access to the entire media content for the purpose of ensuring that the digital media is not downloaded and stored by the user.

### SUMMARY OF SOME EMBODIMENTS INVENTION

Embodiments of the invention provide a method for renting-out media content to users using a plurality of digital kiosk vending machines and rewritable memory devices while ensuring the security of said media content wherein said digital content is played on an external player.

In embodiments of the invention, the method may comprise the step of transferring selected media content from said digital kiosks to said rewritable memory devices.

In embodiments of the invention, the method may comprise the step of transferring at least one segment of the digital content from the memory device to the external players, wherein all transferred segments comprise partial data of the digital content and the media content is available to the user for limited usage.

In embodiments of the invention, the method may comprise the step of transferring media content from a remote server to the digital kiosks.

In embodiments of the invention, the transference may be performed periodically.

In embodiments of the invention, the transference is performed according to user requests.

In embodiments of the invention, the method may include the step of encrypting the digital content before storing it in said memory device.

In embodiments of the invention, the method may include the step of decrypting the digital content by the memory device.

In embodiments of the invention, the method may include the step of decrypting said digital content by said external player.

In embodiments of the invention, the limited usage may be determined according to the time-span passed since performing the rental transaction.

In embodiments of the invention the limited usage may be determined according to the number of times said media content is played by the user.

In embodiments of the invention the method may comprise the step of deleting the media content from the portable device when limited usage terms are exceeded by deleting the pointer of the media content.

In embodiments of the invention, the may comprise the step of enabling users to control the playing sequence of the digital media by giving playing commands.

In embodiments of the invention the playing commands may include at least one of the following: play, stop, pause, rewind, fast forward, skip forward, skip backwards.

In embodiments of the invention, a system is presented for renting-out media content to users using a plurality of digital kiosk vending machines and rewritable memory devices while ensuring the security of said media content wherein said digital content is played on an external player.

In embodiments of the invention, the system may comprise a plurality of rewritable portable memory devices wherein the internal memory of the memory devices may be divided into three sections: secured memory section, usage monitoring section and controller section.

In embodiments of the invention, at least one segment of said digital content is transferred from said memory device to a player, all transferred segments comprise partial data of the digital content and the media content may be available to the user for limited usage.

In embodiments of the invention, the usage monitoring section of said portable memory device measures the time-span passed since said rental transaction.

In embodiments of the invention, the usage monitoring section of the portable memory device may count the amount of times the media content was played by the user.

In embodiments of the invention, the system may comprise a remote server for transferring media content to the digital kiosks.

In embodiments of the invention, the external player may be a desktop or laptop computer comprising a media player application.

In embodiments of the invention, the external player may be a dedicated player box comprising an internal processor, internal monitor, a plurality of communication ports and a media player application.

In embodiments of the invention, the dedicated player box may be integrated into a display monitor.

In embodiments of the invention, the media content may include at least one of the following: movies, video clips, songs.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of the principal components of the rental system in accordance with some embodiments of the present invention;

FIG. 2 is a flowchart illustrating the rental procedure in accordance with embodiments of the present invention;

FIG. 3 is a schematic illustration of the principal components of the media storing playing system of the user in accordance with some embodiments of the present invention;

FIG. 4 is a schematic illustration of the principal components of the playing system in accordance with the second embodiment of the present invention; and

FIG. 5 is a block diagram illustrating the components of a dedicated player box in accordance with the second embodiment of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is an innovative system and method which enable utilizing rewritable portable memory devices, such as flash memory keys, for digital media content rentals, such as movies, video clips and audio files and the like, while ensuring the security of the media content stored on the device. In order to use the proposed media content rental system the users approach dedicated digital media kiosks with a pre-purchased memory device. The users connect the memory device to the digital kiosk and using the graphic user interface (GUI) of the digital kiosk they select the media content they wish to rent. The media content is downloaded to their memory devices and may be played using any standard desktop or laptop computer or using a dedicated player box. The rental agreement defines the number of times the users may play the rented media content or the amount of time the media content would be in their disposal. In order to protect the rented content the memory device limits the accessibility of the content to the users, the users cannot download the entire media content to their computer, and only have access to sections of the media content while playing it.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents., patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

According to embodiments of the present invention the system may include a remote server containing large quantities of digital media content and a plurality of digital kiosks with local databases containing digital media content. Each user of the system may have a portable memory device, e.g., as known in the art, and access to at least one player on which the rented media content may be played. For the purpose of ensuring the security of the media content downloaded to the portable memory devices the memory of these devices may be divided into three sections. The first section contains the entire rented media content. This section cannot be directly accessed by the player. The second section contains a timer which controls the time period over which the media content can be played or a counter which counts the amount of times the media content was played. The third section controls the playing of the media content, by taking parts of the media content and making it available to the player.

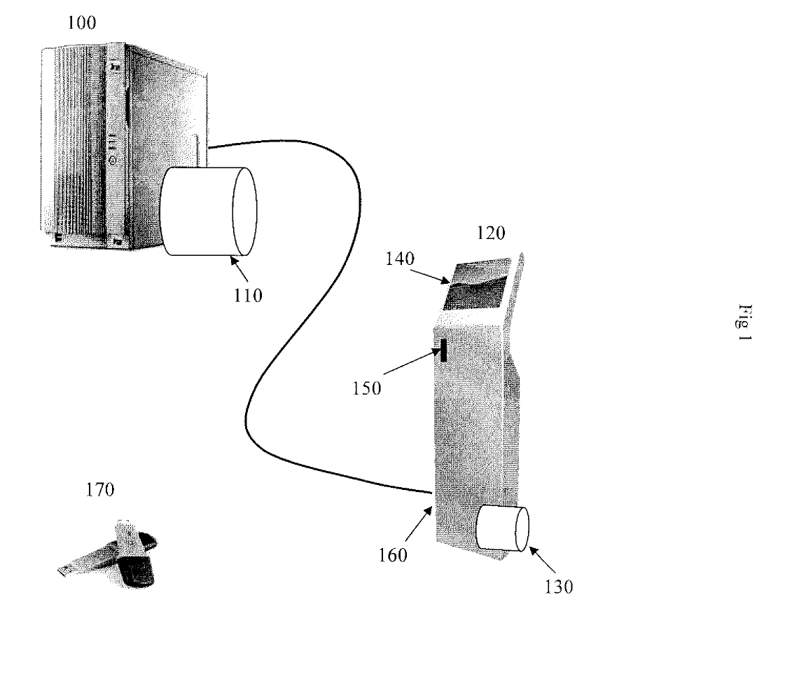

Reference is now made to FIG. 1, which schematically illustrates the components of the rental system in accordance with some embodiments of the present invention. The system may include at least one remote server 100 which hosts database 110. Database 110 contains large quantities of digital media content, such as movies, video clips or audio content and the like. Server 100 communicates with a plurality of digital kiosks 120 through any type of communication means. For instance, this communication means is optionally a wide area network (WAN), a virtual private network (VPN), or any other type of network which is equipped for efficiently transferring large volumes of data.

Digital kiosks 120 are adapted to be vending machine allowing users to rent media content. The system is comprised of a plurality of digital kiosks 120. Digital kiosks 120 are optionally positioned in different locations such as airports, hotels, bus stations and gas stations and the like. Digital kiosks 120 may include an internal database 130 adapted to store media content. Digital kiosk 120 may further include display means 140 for displaying the GUI. Digital kiosk 120 may include two types of communication facilities. The first is long distance transceiver 150 for communicating with remote server 100 and the second is a local communication port 160 for transferring information to portable memory device 170.

Alternatively, according to some embodiments of the present invention all media content available to the users may be stored on database 130 of digital kiosk 120. The transference time of media content from remote server 100 to digital kiosk 120 is substantially reduced, but the variety of the media content and its total volume may be limited due to the size of database 130. The media content stored on database 130 of digital kiosk 120 can be periodically updated from Server 100.

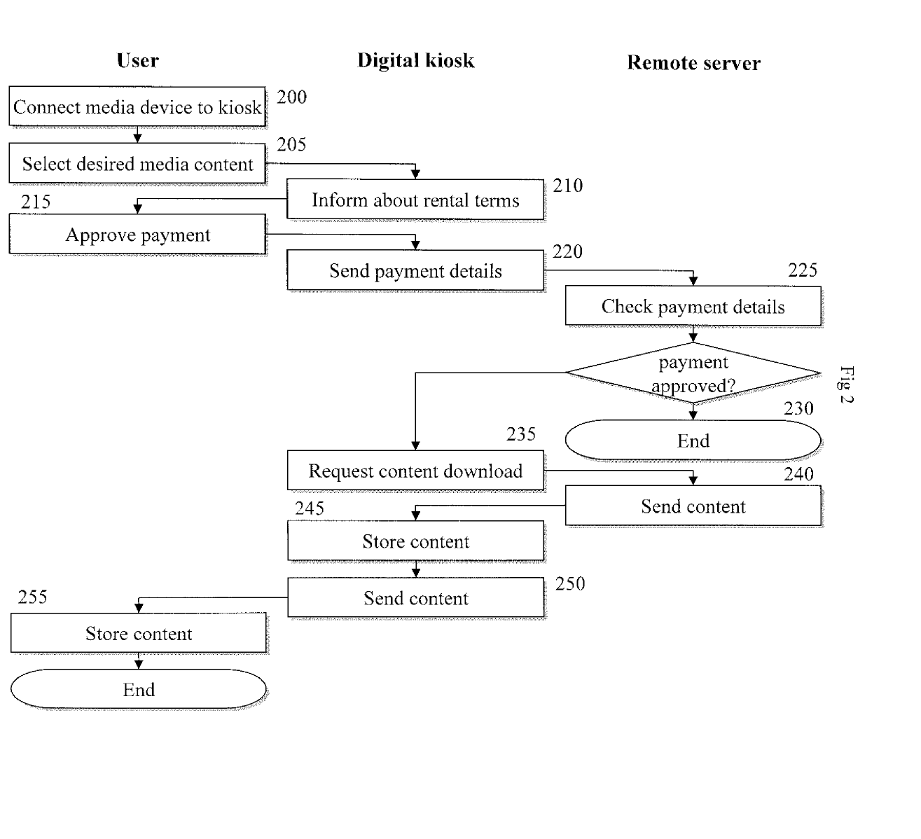

Reference is now made to FIG. 2, which schematically illustrates a flowchart of the method of renting media content in accordance with embodiments of the present invention. In order to rent media content users may approach digital kiosks 120 at any of their locations.

As indicated by box 200, the method may include, for example, the step of connecting pre-acquired rewritable portable memory devices 170 by the user.

As indicated by box 205, the method may include, for example, the step of selecting the desired media content through the GUI of digital kiosk 120.

As indicated by box 210, the method may include, for example, the step of informing the user about rental terms, before the user downloads the media content. These rental terms optionally limit the number of times the media content may be played by the users, the amount of time that the users have access to the media content or any other limitations on the accessibility of the media content to the users.

As indicated by box 215, the method may include, for example, the step of approving payment for the rental of the media content by, e.g., the user.

As indicated by box 220, the method may include, for example, the step of sending payment detail from, e.g., digital kiosk 120 to server 100.

As indicated by box 225, the method may include, for example, the step of verifying the payment details at, e.g., server 100.

As indicated by box 230, the method may include, for example, the step of terminating the process in case the payment details are not confirmed.

As indicated by box 235, the method may include, for example, the step of sending data representing media content which the user selected, e.g., from kiosk 130 to the remote server 100.

As indicated by box 240, the method include, for example, the step of sending data representing the media content, e.g., from its internal database 110 to digital kiosk 120.

As indicated by box 245, the method may include, for example the step of storing the data representing the media content in, e.g., internal database 130. According to embodiments in which all media content is stored on database 130 of digital kiosk 120, steps 240 and 245 may be performed periodically.

As indicated by box 250, the method may include, for example, the step of sending the data representing the media content to device 170.

As indicated by box 255, the method may include, for example, the step of storing the data representing the media content in internal memory of device 170.

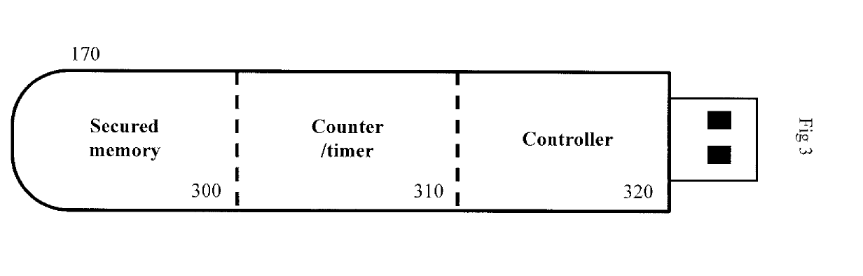

Reference is now made to FIG. 3, which schematically illustrates the memory sections of portable device 170. The memory of portable device 170 may be logically or physically divided into three sections: secured memory 300, counter/timer 310 and controller 320. When the user downloads the rented media content onto device 170, media content is stored in secured memory 300. The media content in secured memory 300 is encrypted and the user does not have direct access to it. Counter/timer section 310 holds all information regarding the number of times the media content has been played by the user, or the amount of time which passed from when the user rented the media content, depending on the rental agreement. If the media content was rented for a predetermined time, section 310 measures the time passed since the content was downloaded; if the rental agreement defines the number of times the content may be played, section 310 counts the number of times the user played the media content. Having completed the predetermined time period or number of times the media content may be played, the media content is automatically deleted from secured memory 300. The deletion of media content may optionally be performed by deleting its pointer.

Controller section 320 may be responsible for transmitting the media content from the secured memory 300 to the external player. Controller 320 receives data requests from the external player on which the user wishes to play the media content. For example, when the user connects device 170 to the external player, the external player may ask for the type of media content stored in device 170, and its title and details. When the user gives the Play command to the player the player transfers this command to controller 320 on device 170. Similarly, when the user gives the player any other command, such as Stop, Pause, Rewind, Fast Forward and Skip, the player transfers these commands to controller 320.

When controller 320 receives a request to play the media content, it first checks that the user still has access to the media content according to the information stored in counter/timer 310. Provided that the media content is still available for the user, controller extracts a segment of the media content, decrypts it and sends it to the external player. At no time does controller 320 transmit the entire media content to the player; controller 320 always sends only segments of the media content. Thus, the media content is never available to the users in its entirety at any point in time. This manner of operation ensures the security of the media content stored on device 170.

Since only segments of the media content may be available to the users at any point in time, the users cannot access the media content in its entirety and download it to their computer. When the users play the media content in normal mode, by giving the player a Play command, controller 320 sends sequential segments of the media content to the player. When the users give Fast Forward, Rewind or Skip commands, controller 320 sends the appropriate segments to the player accordingly.

In order to play the media content the users connect memory device 170 to a processing machine which has the appropriate communication port for connecting memory device 170, a player and display means. If, for instance, memory device is a flash memory key, which can connect using a universal serial bus (USB), it can only connect to processing machines which have a USB type ports. The player on which the user plays the media content may be any type of player adapted for the type of media in the media content. For instant, if the media content may include movies in any of the Moving Picture Experts Group (MPEG) formatss, any player which can play MPEG files may be used.

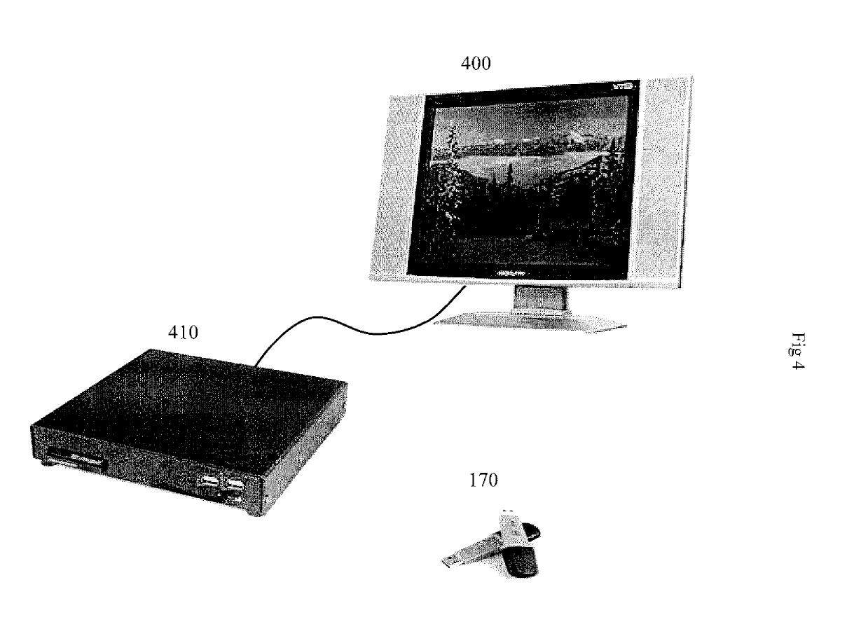

According to one embodiment of the present invention the processing machine is a desktop or a laptop computer. According to a second embodiment of the present invention, the processing machine is a dedicated player box. FIG. 4 is a schematic illustration of the principal components of the playing system in accordance with the second embodiment of the present invention. The system is comprised of displaying means 400, such as a television set and a dedicated player box 410 which can connect to the memory device 170.

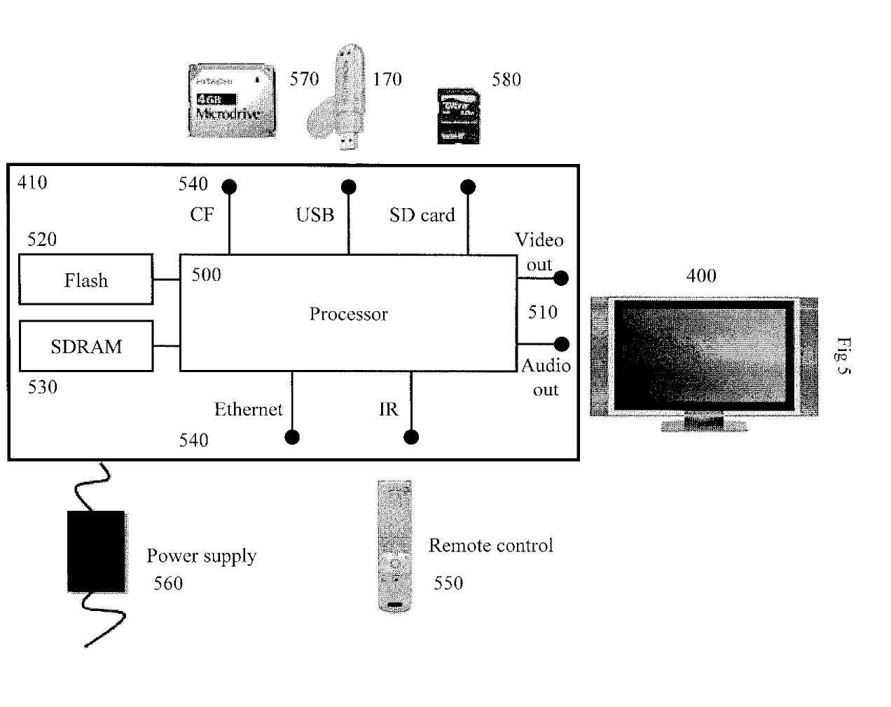

FIG. 5 is a block diagram illustrating the components of a dedicated player box in accordance with the second embodiment of the present invention. Player box 410 may include a processor 500, an internal flash memory 520, a Synchronous Dynamic Random Access Memory (SDRAM) chip 530, display connectors 510 and a plurality of communication ports 540. Player box 410 may be an external box or integrated into display monitor 400. The plurality of communication ports 540 enable it to connect to memory device 170, communicate with remote control 550, security digital (SD) card 580, Compact Flash (CF) card 570, internet, intranet, or any other communication format. Player box 410 receives commands from the user through remote control 550, processes them and sends requests for data from portable memory device 170 which holds the media content. The media content which device 170 transfers to player box 410 are stored in internal flash memory 520 and played on a player application installed on player box 410. The video and audio signals are transmitted to the display monitor 400 through display connectors 510.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for renting-out media content to users using a plurality of digital kiosk vending machines and rewritable memory devices while ensuring the security of said media content wherein said digital content is played on an external players said method comprising the steps of:
transferring selected media content from said digital kiosks to said rewritable memory devices;
transferring at least one segment of said digital content from said memory device to said external player wherein all transferred segments comprise partial data of said digital content and the media content is available to the user for limited usage.

2. The method of claim 1 further comprising the step of transferring media content from a remote server to said digital kiosks.

3. The method of claim 2 wherein said transference is performed periodically.

4. The method of claim 2 wherein said transference is performed according to user requests.

5. The method of claim 1 further comprising the step of encrypting said digital content before storing it in said memory device.

6. The method of claim 5 further comprising the step of decrypting said digital content by said memory device.

7. The method of claim 5 further comprising the step of decrypting said digital content by said external player.

8. The method of claim 1 wherein said limited usage is determined according to the time-span passed since performing the rental transaction.

9. The method of claim 1 wherein said limited usage is determined according to the number of times said media content is played by the user.

10. The method of claim 1 further comprising the step of deleting said media content from said portable device when limited usage terms are exceeded by deleting the pointer of said media content.

11. The method of claim 1 further comprising the step of enabling users to control the playing sequence of said digital media by giving playing commands.

12. The method of claim 11 wherein said playing commands include at least one of the following: play, stop, pause, rewind, fast forward, skip forward, skip backwards.

13. A system for renting-out media content to users using a plurality of digital kiosk vending machines and rewritable memory devices while ensuring the security of said media content wherein said digital content is played on an external player, said system comprising:
a plurality of rewritable portable memory devices wherein the internal memory of said memory devices is divided into three sections: secured memory section, usage monitoring section and controller section.
wherein at least one segment of said digital content is transferred from said memory device to a player, all transferred segments comprise partial data of said digital content and the media content is available to the user for limited usage.

14. The system of claim 13 wherein said usage monitoring section of said portable memory device measures the time-span passed since said rental transaction.

15. The system of claim 13 wherein said usage monitoring section of said portable memory device counts the amount of times said media content was played by the user.

16. The system of claim 13 further comprising a remote server for transferring media content to said digital kiosks.

17. The system of claim 13 wherein the external player is a desktop or laptop computer comprising a media player application.

18. The system of claim 13 wherein said external player is a dedicated player box comprising an internal processor, internal monitor, a plurality of communication ports and a media player application.

19. The system of claim 18 wherein said dedicated player box is integrated into a display monitor.

20. The system of claim 13 wherein said media content includes at least one of the following: movies, video clips, songs.
